(19) United States
(12) Patent Application Publication
(10) Pub. No.: US 2004/0178124 A1
(43) Pub. Date: Sep. 16, 2004

(54) Hydrogen desulfurizer for hydrocarbon feeds with separated adsorption and catalyst material

(76) Inventors: Ke Liu, East Longmeadow, MA (US); Peter F. Foley, Manchester, CT (US); Eric A. Rohrbach, Lebanon, CT (US); Francis A. Kocum, Glastonbury, CT (US); Jian Sun, Simsbury, CT (US)

Correspondence Address: M. P. Williams, Patent Counsel, 210 Main Street, Manchester, CT, 06040, US

(21) Appl. No.: 10/386,317

(22) Filed: Mar. 11, 2003

(51) Int. Cl. C10G 45/00; B01J 8/04; B01J 8/02

(52) U.S. Cl. 208/213; 208/210; 422/188; 422/190; 422/193

(57) ABSTRACT

A hydrogen desulfurizer (11) includes a tank (17) designed for downflow of hydrocarbon feedstock containing a plurality of layers (41-44) of catalyst interspersed with layers (46-49) of adsorbent. The layers may all comprise baskets, the adsorbent comprising pellets, such as zinc oxide pellets; the catalysts may be wash-coated on catalyst support such as monolith or foams, or may be wash-coated on netted wire mesh instead of being contained in a basket. The catalyst is heated to between about 442° F. (250° C.) and about 932° F. (500° C.). A mini-CPO (36) supplies hydrogen to the desulfurizer (11). Heaters (53, 55), which may either be electric or circulating heated fluid may also be used.

### TECHNICAL FIELD

This invention relates to a hydrogen desulfurizer (HDS) in which the sulfur adsorbent material, such as zinc oxide, is kept separate from the hydrogen desulfurization (HDS) catalyst by means of a wire basket for the adsorbent or by packing adsorbent pellets between layers of HDS catalyst, and providing the catalyst in the form of wash-coated support, such as netted mesh, monolith, foam, etc., or in the form of pellets in a basket. Several layers of adsorbent are interspersed with several layers of catalyst.

### BACKGROUND ART

Sulfur-free hydrogen is produced from hydrocarbon feeds for a variety of uses, such as fuel for fuel cell power plants. Current technology includes conversion of hydrocarbon feeds to hydrogen by passing natural gas, or other hydrocarbon fuels, through a desulfurizer, a reformer, a water-gas shift reactor, and a preferential carbon monoxide oxidizer. The hydrogen may be used as fuel in a fuel cell power plant, in refineries, or in other processes.

An exemplary hydrogen desulfurizer utilizes a mix of sulfur adsorbent and HDS catalyst in a large container through which the feed stock is passed. For instance, zinc oxide pellets may be mixed with support pellets which have been wash-coated with a precious metal HDS catalyst, such as platinum. Although the precious metal catalyst is effective substantially indefinitely, the ZnO adsorbent will turn into ZnS over time. When a substantial portion of the zinc oxide pellets have become ZnS, the mixture of the HDS catalyst and adsorbent pellets has to be changed. Even though the catalyst may still be useful, there is no economical way to separate the catalyst pellets from the zinc oxide pellets. This results in significant, expensive waste as well as generating environmental problems by disposing of the catalyst/adsorbent mixture.

### DISCLOSURE OF INVENTION

Objects of the invention include provision of a hydrogen desulfurizer in which the adsorbent pellets can be changed without separation from or other removal the catalyst pellets; a hydrogen desulfurizer in which the precious metal HDS catalyst can be used indefinitely or recycled to reclaim the precious metal, despite the need to change the adsorbent material; a hydrogen desulfurizer which does not waste precious metal catalyst; a hydrogen desulfurizer in which changing of the adsorbent material may be effected easily on an as-needed basis.

This invention is predicated on the discovery that hydrogen sulfide poisoning of a precious metal catalyst in a hydrogen desulfurizer can be minimized, even when the adsorption material is not completely mixed with the precious metal catalyst, by raising the temperature of the process to at least about 572° F. (300° C.) or more, and in part on the discovery that at high temperature, such as about 750° F. (400° C.), the precious metal catalysts can convert sulfur compounds, such as thiophene, into hydrogen sulfide to be captured on the adsorbent material, such as zinc oxide, to reduce the sulfur compounds to below 25 parts per billion, without having the catalyst in intimate contact with the adsorbent. Since intimate contact is not required, the catalyst and adsorbent can be packed separately.

According to the invention, several layers of adsorbent material are interspersed with several layers of precious metal HDS catalyst material in a hydrogen desulfurizer operating at a temperature of between 482° F. (250° C.) and 932° F. (500° C.), but preferably between 660° F. (350° C.) and 842° F. (450° C.). According further to the invention, each layer of catalyst may comprise a support, such as netted mesh, a monolith or a foam, which is wash-coated with precious metal catalyst such as platinum. In still further accord with the invention, the adsorbent may be in supported form, or it may be in pellet form, which is cheaper.

In a down-flow hydrogen desulfurizer, the highest layer of zinc oxide is easily replaced, without necessarily replacing other layers of zinc oxide, which is expedient because the highest layer will become exhausted much sooner than other, lower layers.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified schematic diagram of a hydrogen desulfurizer having layers of separately contained catalyst and adsorbent, in accordance with the invention.

FIG. 2 is a simplified, partial side elevation section of the catalyst and adsorbent layers of the invention.

FIG. 3 is a bottom plan view of a basket bottom.

FIG. 4 is a simplified, partial side elevation section of an HDS with heaters.

### MODE(S) FOR CARRYING OUT THE INVENTION

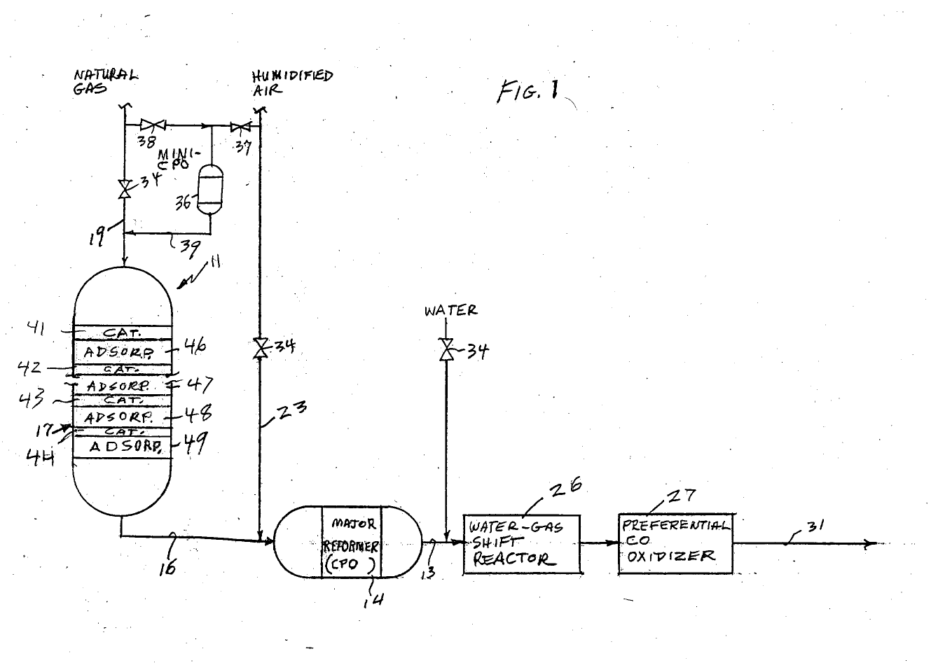

Referring to FIG. 1, hydrogen reformate is generated in a line 13 by a major reformer 14, such as a catalytic partial oxidizer (CPO), an auto-thermal reformer or a steam reformer, which in turn receives desulfurized hydrocarbon fuel, such as natural gas, over a line 16 from a hydrogen desulfurizer 11. The hydrogen desulfurizer 11 receives hydrocarbon fuel over a line 19. The CPO 14 also receives humidified air, from a suitable source such as an enthalpy recovery device, over a line 23. In the CPO 14, the hydrocarbons in the fuel react with the humidified air on a catalyst, such as rhodium, iridium or zirconia, to produce in the line 13 reformate which, for methane feedstock, is roughly 37% hydrogen, 14% CO, 4% CO₂ and traces of other gases, which is further processed with water from a line 24 in a water-gas shift reactor 26 and a preferential CO oxidizer 27 to make it suitable for use as fuel in a line 31, such as for a fuel cell.

In one embodiment of the invention, a mini-CPO 36, about the size of a 12 ounce beverage can, receives humidified air through a valve 37 and receives hydrocarbon fuel, such as natural gas, through a fixed orifice 38. The multiplicity of valves 34, 37 and the fixed orifice 38 allows adjusting the correct flows to the mini-CPO, the hydrogen desulfurizer and the major reformer. In the mini-CPO, the fuel, which for natural gas, is typically more than 99% methane with traces of sulfur compounds, nitrogen and other hydrocarbons, is converted, along with the humidified air, to reformate, which may comprise roughly 30% hydrogen, 12% CO, and small amounts of other gases such as CO₂ and H₂O, nitrogen from the humidifier, and unconverted hydrocarbons.

The reformate produced by the mini-CPO 36 in a line 39 is mixed with the fuel at the inlet to the hydrogen desulfurizer 11.

Since no water is applied to the mini-CPO, the reformate is dry, which enhances the adsorption on zinc oxide and helps to reduce the sulfur to the parts per billion level.

Although there is carbon monoxide in the CPO reformate, the heat input from the mini-CPO helps the hydrogen desulfurizer to run at between 650° F. (343° C.) and 750° F. (400° C.); heat from other sources may optionally be supplied. These temperatures are high enough so that the carbon monoxide has only a relatively small negative effect on the desulfurizer catalyst.

According to the invention, the hydrogen desulfurizer 17 has separately contained layers 41-44 (such as platinum or other precious metal) interspersed with layers 46-49 of separately contained adsorbent, such as zinc oxide. In a down flow desulfurizer, as illustrated in FIG. 1, the adsorbent layer 46 will become saturated by sulfur more quickly than the adsorbent layers 47-49. A feature of the invention is that the layer 46 is easily exchanged by temporarily removing the catalyst layer 41, installing a new adsorbent layer 46, and reinstalling the catalyst layer 41. When proper, all of the catalyst layers and adsorbent layers can be removed, and then new adsorbent layers can be installed interspersed with the old catalyst layers.

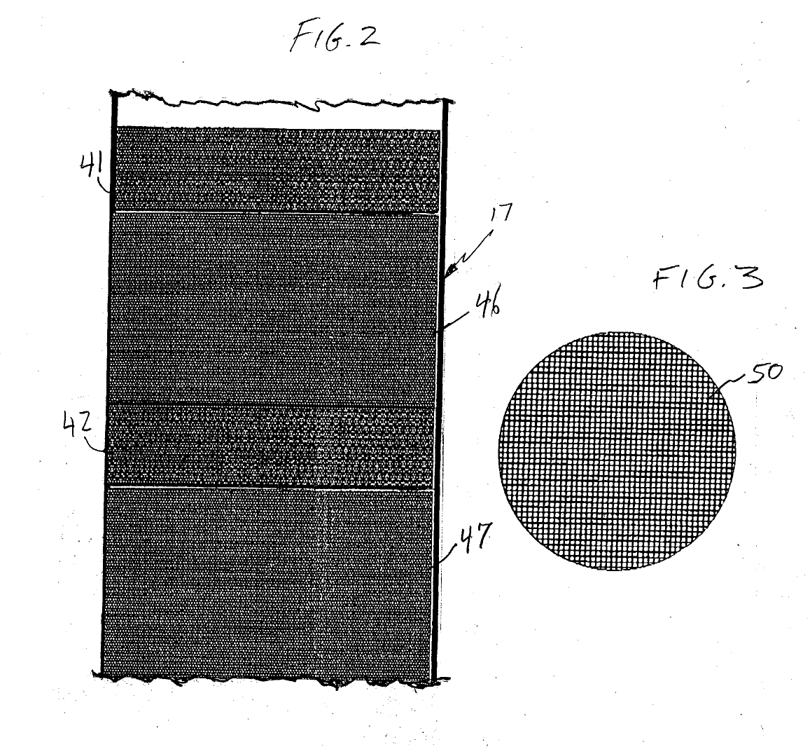

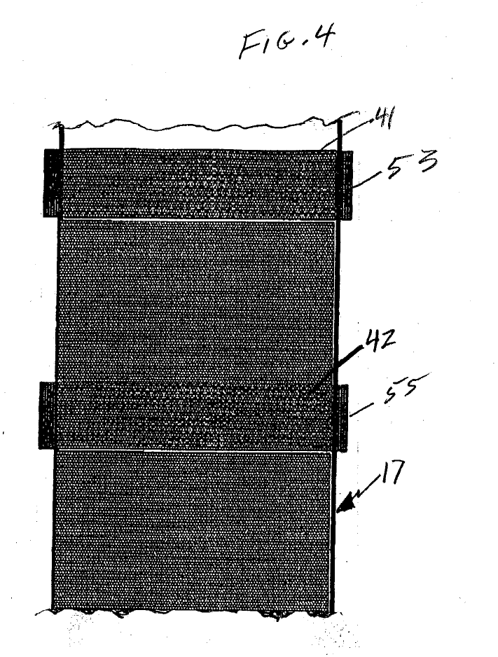

Referring to FIG. 2, a first embodiment of the invention employs baskets 41, 42 for the catalyst as well as baskets 46, 47 for the adsorbent. Typically, the hydrogen desulfurizer 11 will be formed in a generally cylindrical tank 17, and therefore the baskets 41, 42, 46, 47 will have cylindrical vertical walls and flat bottom walls. The cylindrical vertical walls may be either solid or mesh, but the bottom walls must be mesh or screens as illustrated by the screen bottom wall 50 in FIG. 3. In that embodiment, the HDS catalyst may be wash-coated on any suitable catalyst support such as monolith, netted mesh or foam, or other mass produced structured catalyst support.

In a second embodiment of the invention, a woven, netted wire mesh in the shape of a cylinder (the same as the overall dimension of a basket) is wash-coated with the HDS catalyst then used in place of a basket filled with wash-coated catalyst supports. Alternatively, ZnO pellets may be packed between layers of supported HDS catalyst.

In the embodiment of FIG. 1, the hydrogen desulfurizer 11 is raised to a suitable temperature of about 660° F. (350° C.) or more by heat in the reformate produced by the mini-CPO 36. The catalyst may be heated in any other suitable way, such as by means of annular banded heaters 52 surrounding the outside of the hydrogen desulfurizer tank 17 in the regions adjacent the catalyst, as illustrated in FIG. 4. The heaters 53, 55 may be electric, or they may circulate air or liquid heated externally either by waste heat taken from a related process, or by consumption of the feedstock, in any of a number of well-known fashions.

Furthermore, heat exchangers may preheat the hydrocarbon feed and the humidified air stream; this is especially beneficial in the case when a mini-CPO is not utilized, but the hydrogen is supplied to the hydrogen desulfurizer 11 in some other fashion (such as using a prior art hydrogen blower to return hydrogen from the output on line 31).

The netted wire mesh support, if used, and the baskets may be made of suitable material which is robust enough to withstand exposure to the hydrogen desulfurization environment for several years, as necessary. Candidate materials include stainless steel or other alloys.

In the foregoing, the adsorbent units 41-44 are shown as being disposed contiguously with the adsorption units 46-49; however, that is not necessary.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

We claim:

1. A hydrogen desulfurizer, comprising:
a tank having a flow axis;
a plurality of catalyst units of separately packaged hydrogen desulfurization catalyst through which hydrocarbon feedstock may flow in a direction parallel to said flow axis; and
a plurality of adsorption units of separately packaged sulfur adsorbent material through which hydrocarbon feedstock may flow in a direction parallel to said flow axis;
said units being disposed in said tank with said catalyst units interleaved with said adsorption units.

2. A hydrogen desulfurizer comprising:
a plurality of layers of hydrogen desulfurization catalyst interspersed with a plurality of layers of sulfur adsorbent material separate from said catalyst.

3. A hydrogen desulfurizer according to claim 2 wherein:
said adsorbent material comprises pellets packed between layers of supported catalyst.

4. A hydrogen desulfurizer according to claim 1 or 2 wherein:
said catalyst is disposed in baskets having screens in the bottom thereof to allow flow of feedstock therethrough.

5. A hydrogen desulfurizer according to claim 4 wherein:
said catalyst is wash-coated on a support of monolith, netted mesh or foam.

6. A hydrogen desulfurizer according to claim 1 or 2 wherein:
said catalyst is wash-coated onto a support of monolith, netted mesh or foam.

7. A hydrogen desulfurizer according to claim 1 or 2 wherein:
said catalyst contains platinum.

8. A hydrogen desulfurizer according to claim 1 or 2 wherein:
said adsorption material is disposed in baskets having screens in the bottom thereof to allow flow of feedstock therethrough.

9. A hydrogen desulfurizer according to claim 1 or 2 wherein said adsorption material is zinc oxide pellets.

10. A hydrogen desulfurizer comprising:
a plurality of layers of hydrogen desulfurization catalyst interspersed with a plurality of layers of sulfur adsorbent material separate from said catalyst material; and
means for heating said catalyst to between about 442° F. (250° C.) and about 932° F. (500° C.).

11. A hydrogen desulfurizer according to claim 10 wherein:
said means heats said catalyst to between about 660° F. (350° C.) and 842° F. (450° C.).

12. A method of desulfurizing hydrocarbon feedstock, comprising:
providing a plurality of layers of hydrogen desulfurization catalyst interspersed with a plurality of layers of adsorption material separate from said catalyst material; and
heating said catalyst to between about 442° F. (250° C.) and about 932° F. (500° C.) or more.

13. A method according to claim 12 wherein:
said step of heating comprises heating said catalyst to between about 660° F. (350° C.) and about 842° F. (450° C.).
